(19) United States
(12) Patent Application Publication
(10) Pub. No.: US 2020/0059259 A1
(43) Pub. Date: Feb. 20, 2020

(54) PROTECTIVE DISPLAY DEVICE

(71) Applicant: Naletova Nominees Pty Ltd, Melbourne (AU)

(72) Inventors: Dale John QUILL, St Helena (AU); Thomas Christopher BLACKWELL, Cheltenham (AU); Michael SMITH, Keilor (AU)

(73) Assignee: Naletova Nominees Pty Ltd, Melbourne (AU)

(21) Appl. No.: 16/104,757

(22) Filed: Aug. 17, 2018

(51) Int. Cl. H04B 1/3888; H04M 1/725; H04M 1/02

(52) U.S. Cl. CPC H04B 1/3888; H04M 1/0254; H04M 1/72575

(57) ABSTRACT

A protective display device (10) for a mobile communication device (11) having a first electronic screen, the protective display device (10) comprising: a casing (15) defining a cavity that conforms at least partially to the rear outer shape of the mobile communication device (11), the casing (15) configured to releasably engage the mobile communication device (11); an upper opening (30) of the casing (15) positioned and sized to avoid obstructing a plurality of rear electronic components located on the rear side of the mobile communication device (11); a second electronic screen (20) that is different from the first electronic screen and is attached to the casing (15) such that the second electronic screen (20) is visible to a user when the device (10) is attached to the mobile communication device (11); a communications module (23) housed within a thickness of the casing (15) configured to transmit and receive data from the mobile communication device (11) and/or Internet; a computer processor (16) housed within a thickness of the casing (15) operatively connected to the second electronic screen (20) that is configured to control an image displayed by the second electronic screen (20) in accordance with data received from the communications module (23); and at least one rechargeable power cell (24) housed within a thickness of the casing (15) to supply power to the second electronic screen (20), communications module (23) and computer processor (16), and when the casing (15) is engaged with the mobile communication device (11) the at least one rechargeable power cell (24) is configured to supply power to the mobile communication device (11) and receive power via the mobile communication device (11) if being charged from a power outlet.

### FIELD OF THE INVENTION

The present invention relates to a protective display device.

### BACKGROUND TO THE INVENTION

If the owner of a mobile communication device such as a mobile phone or table has used their device for any appreciable amount of time, the device is likely to be customised by installation and configuration of various applications and by accumulation of personal data such as photographs, videos and collected music. Consequently, such devices are often insured to avoid the cost of replacement. To protect these devices, many are often placed within a decorative and/or protective accessory such as a silicone case or plastic case. Often such accessories are both protective and decorative in purpose. Conventional decorative protective accessories are static in nature allowing no variability in purpose and are unable to facilitate any additional user interaction with the mobile communication device.

Most modern mobile phones do not permit their battery source to be easily replaced when after prolonged use and a number of recharges later, the battery is no longer able to hold a charge or has a reduced charge capacity. Such modern mobile phones are simply replaced for a newer model or on rare occasions booked into a repair shop for disassembly in order to replace the battery.

Mobile phones allow for multi-tasking whereby multiple applications can be loaded simultaneously, however, due to the size of the screen, generally requires the user to switch between screens in order to view the content easily. The switching between screens is a time-consuming activity for the user especially if they must do this frequently between at least two frequently used software apps such as an e-mail client, calendar app or web browser.

### SUMMARY OF THE INVENTION

The inventive concept arises from a recognition that additional functionality provided to a mobile communication device such as a mobile phone using an unobtrusive device is desirable. Additional functionality may include protecting the mobile communication device from accidental physical damage, provided an emergency power source, increasing the total aggregate area for electronic display purposes and facilitating additional user input. Physically protecting an expensive mobile phone using a less costly device which enhances user interaction through visual customisation that is readily changeable, and an additional electronic screen controlled by useful software applications is highly desirable.

The present invention, in one aspect, comprises a protective display device for a mobile communication device having a first electronic screen. The protective display device comprises a casing defining a cavity that conforms at least partially to the rear outer shape of the mobile communication device. The casing is configured to releasably engage the mobile communication device. The protective display device also comprises an upper opening of the casing positioned and sized to avoid obstructing a plurality of rear electronic components located on the rear side of the mobile communication device. The protective display device also comprises a second electronic screen that is different from the first electronic screen and is attached to the casing such that the second electronic screen is visible to a user when the device is attached to the mobile communication device. The protective display device also comprises a communications module housed within a thickness of the casing configured to transmit and receive data from the mobile communication device and/or Internet. The protective display device also comprises a computer processor housed within a thickness of the casing operatively connected to the second electronic screen that is configured to control an image displayed by the second electronic screen in accordance with data received from the communications module. The protective display device also comprises at least one rechargeable power cell housed within a thickness of the casing to supply power to the second electronic screen, communications module and computer processor. When the casing is engaged with the mobile communication device the at least one rechargeable power cell is configured to supply power to the mobile communication device and receive power via the mobile communication device if being charged from a power outlet.

In one embodiment, the communications module may be a wireless communications module. In another embodiment, the communications module may be provided via a USB connector or plug that is insertable into a USB port of the mobile communication device.

The casing may comprise a plurality of openings and recesses positioned and sized to expose a volume rocker, power switch button, power supply port, speaker and microphone of the mobile communication device.

The plurality of rear electronic components may include any one from the group consisting of: camera, image sensor, image processor, LED flash module, ambient light sensor, and fingerprint scanner.

The device may further comprise a USB port configured to provide power from the rechargeable battery to the mobile communication device via a USB cable, and to connect to a USB mass storage device for file transfer

The second electronic screen may be a touchscreen display.

The second electronic screen may have a predetermined size of at least half the superficial area of a rear side surface of the mobile communication device.

The casing may comprise a peripheral side wall to resiliently engage with a peripheral side of the mobile communication device.

The peripheral side wall of the casing may comprise a plurality of buttons including an on/off button.

Other advantages and features according to the invention will be apparent to those of ordinary skill upon reading this application.

### BRIEF DESCRIPTION OF THE DRAWINGS

Embodiments of the invention will be described with respect to the figures, in which like reference numbers denote like elements and in which:

FIG. 1 is a rear side view of a protective display device in accordance with a preferred embodiment of the present invention;

FIG. 2 is a bottom view of the protective display device of FIG. 1;

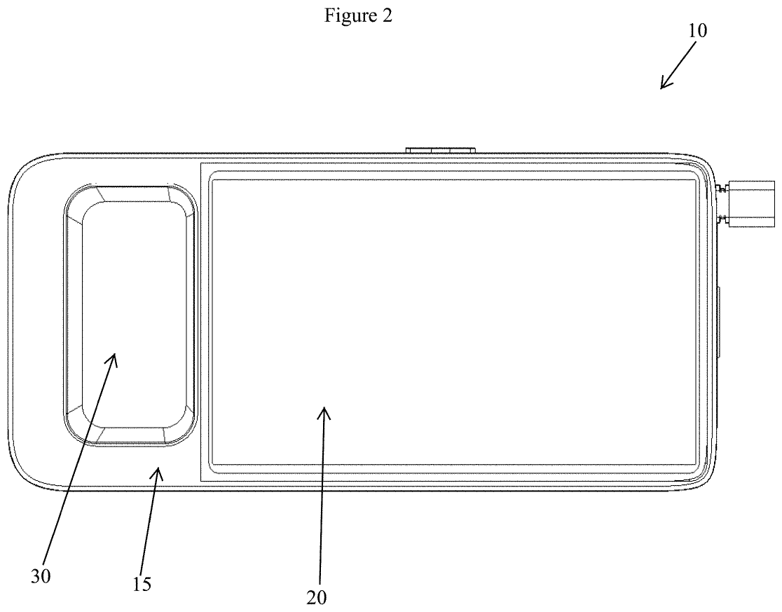

FIG. 3 is a front side view of the protective display device of FIG. 1;

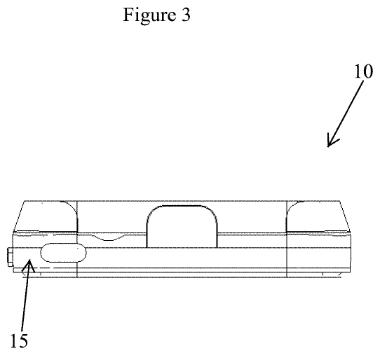

FIG. 4 is a left side view of the protective display device of FIG. 1;

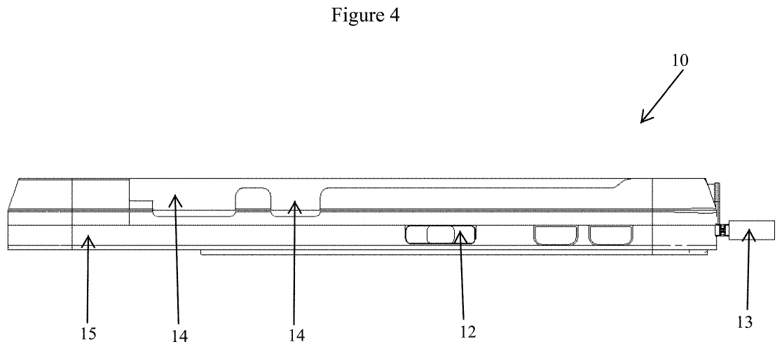

FIG. 5 is a bottom perspective view of the protective display device of FIG. 1;

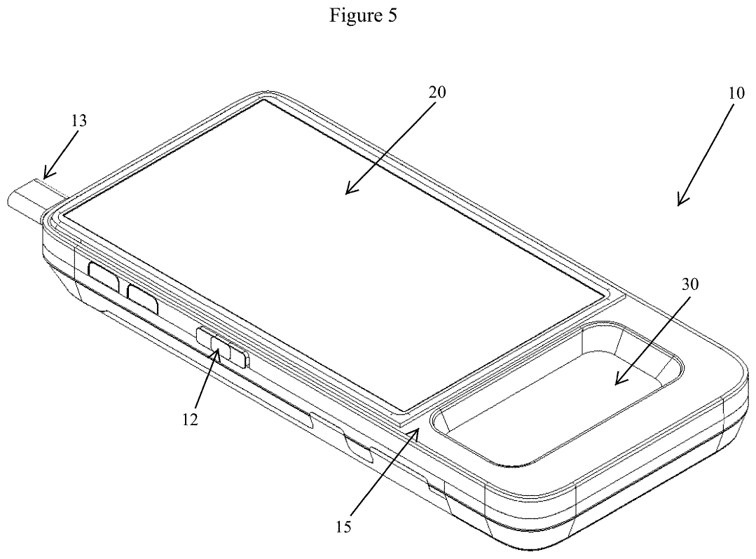

FIG. 6 is a bottom perspective view of the protective display device of FIG. 1;

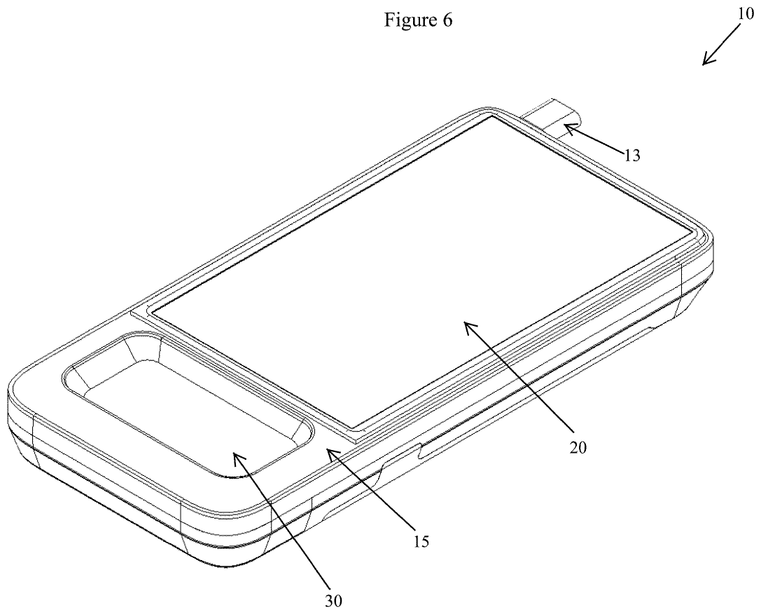

FIG. 7 is a bottom perspective view of the protective display device of FIG. 1;

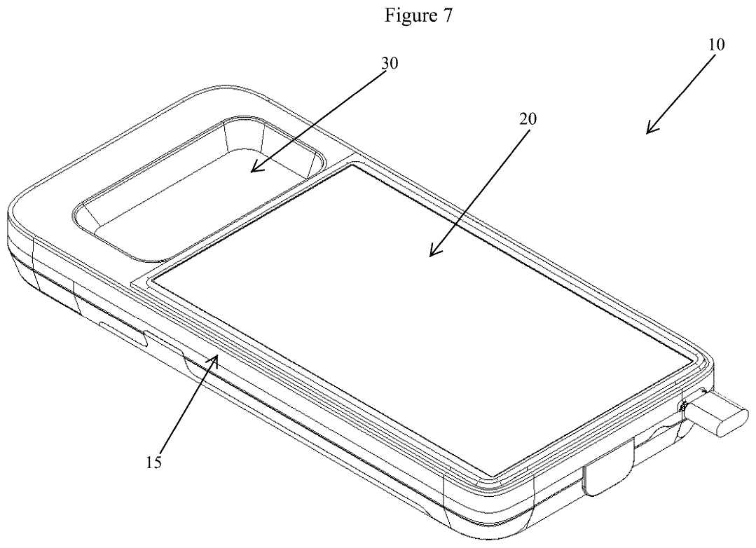

FIG. 8 is a bottom perspective view of the protective display device of FIG. 1;

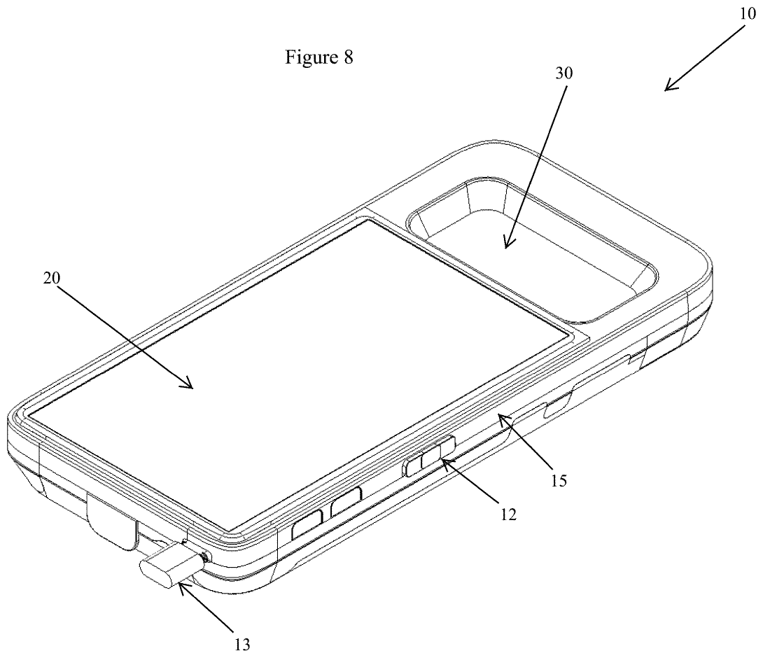

FIG. 9 is a perspective sectional view of the protective display device of FIG. 1;

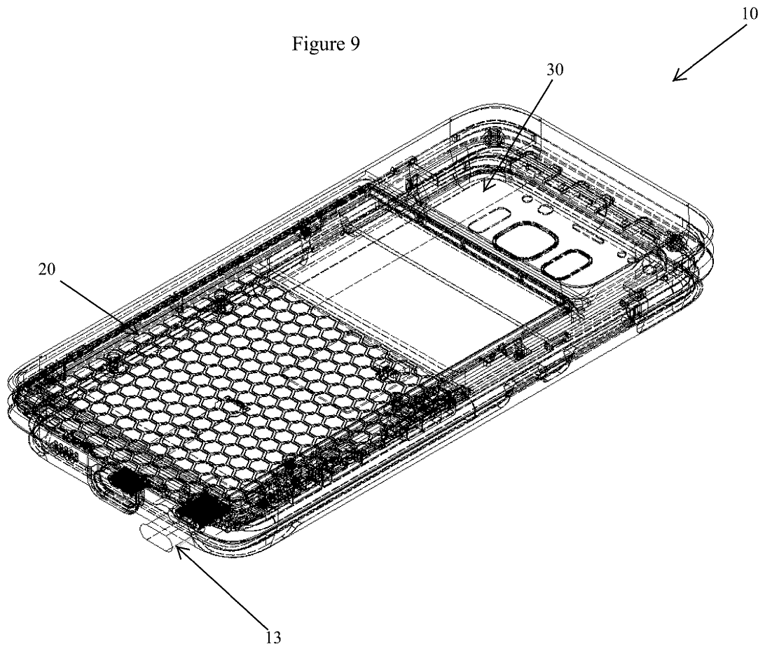

FIG. 10 is a top sectional view of the protective display device of FIG. 1;

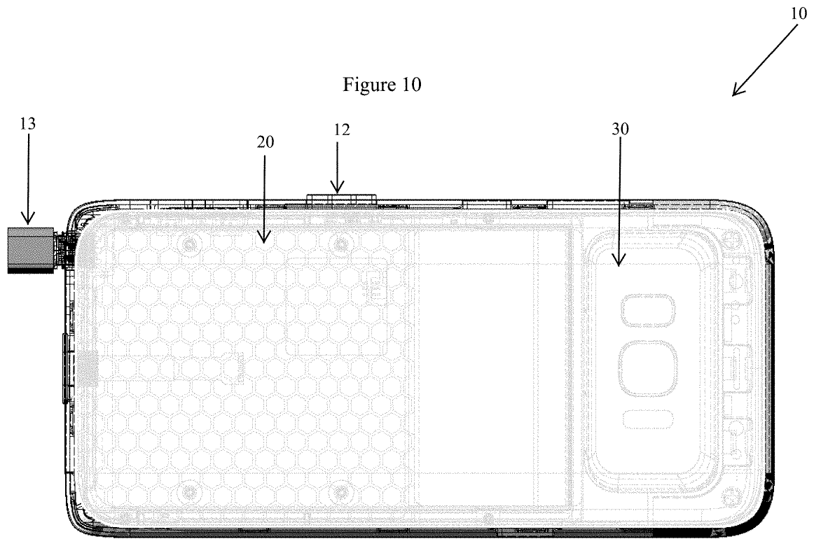

FIG. 11 is a top perspective view of the protective display device of FIG. 1;

FIG. 12 is a top perspective view of the protective display device of FIG. 1;

FIG. 13 is a top perspective view of the protective display device of FIG. 1;

FIG. 14 is a top perspective view of the protective display device of FIG. 1;

FIG. 15 is a right side view of the protective display device of FIG. 1;

FIG. 16 is a top perspective view of the protective display device of FIG. 1;

FIG. 17 is a hardware component diagram of the protective display device of FIG. 1;

FIG. 18 is a photo of a display screen and electronic components of the protective display device of FIG. 1;

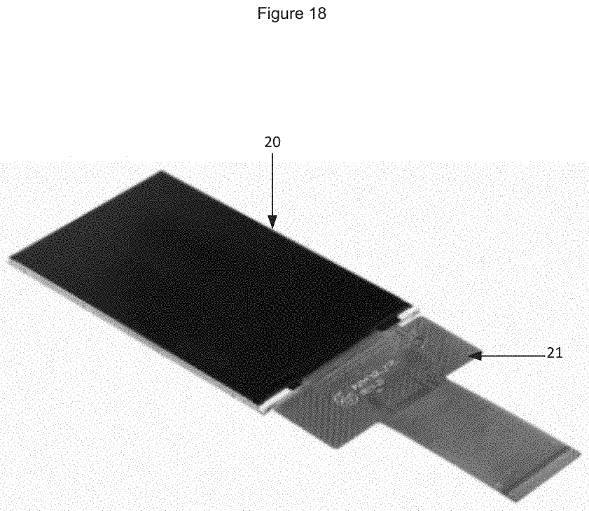

FIG. 19 is a software functionality diagram for operating the protective display device of FIG. 1;

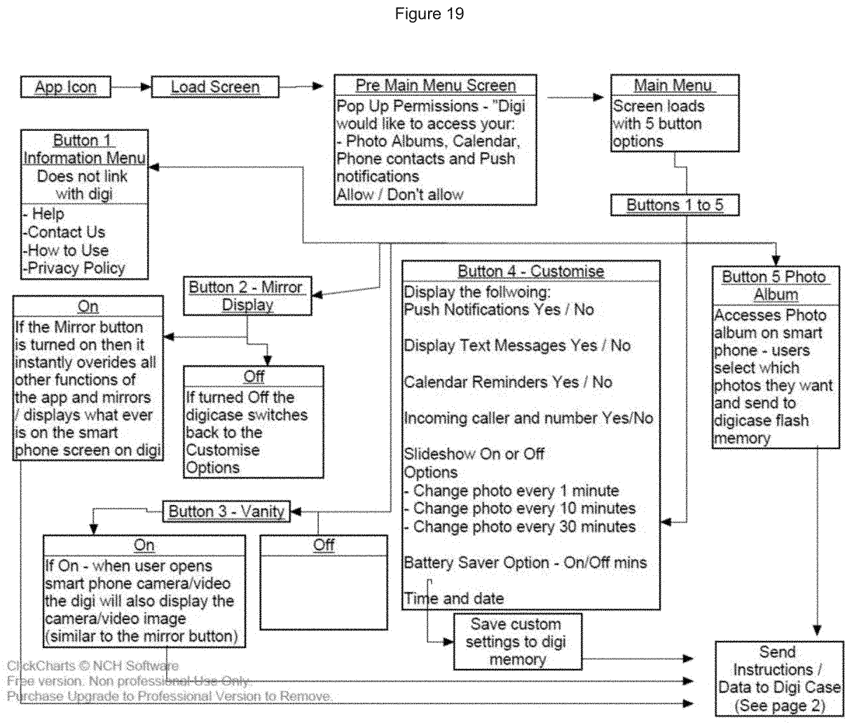

FIG. 20 is a software functionality diagram for operating the protective display device of FIG. 1;

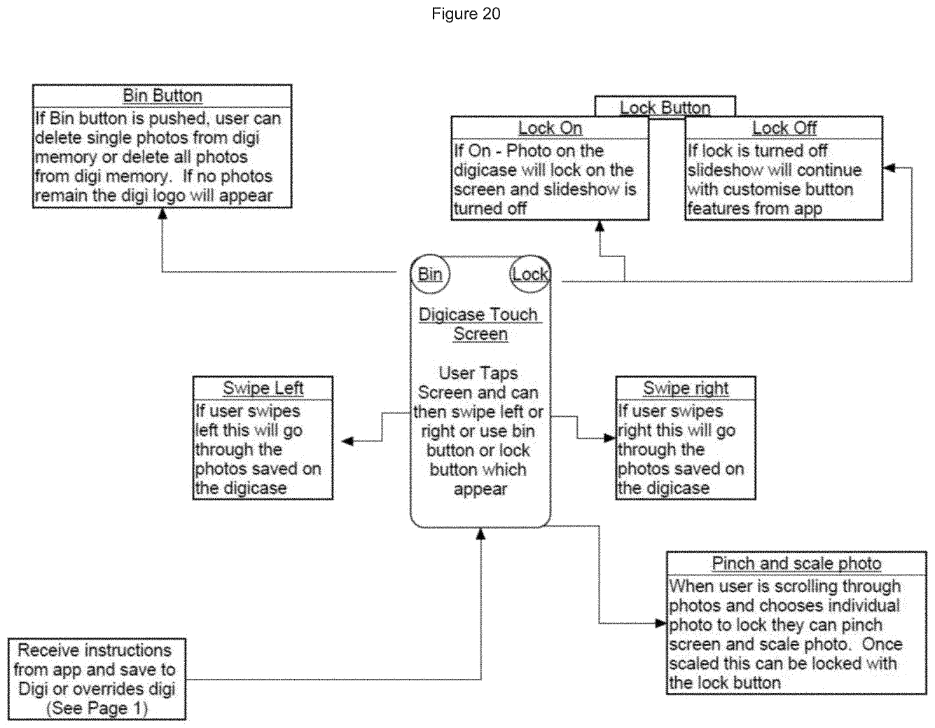

FIG. 21 is a top perspective view of a render of the protective display device of FIG. 1;

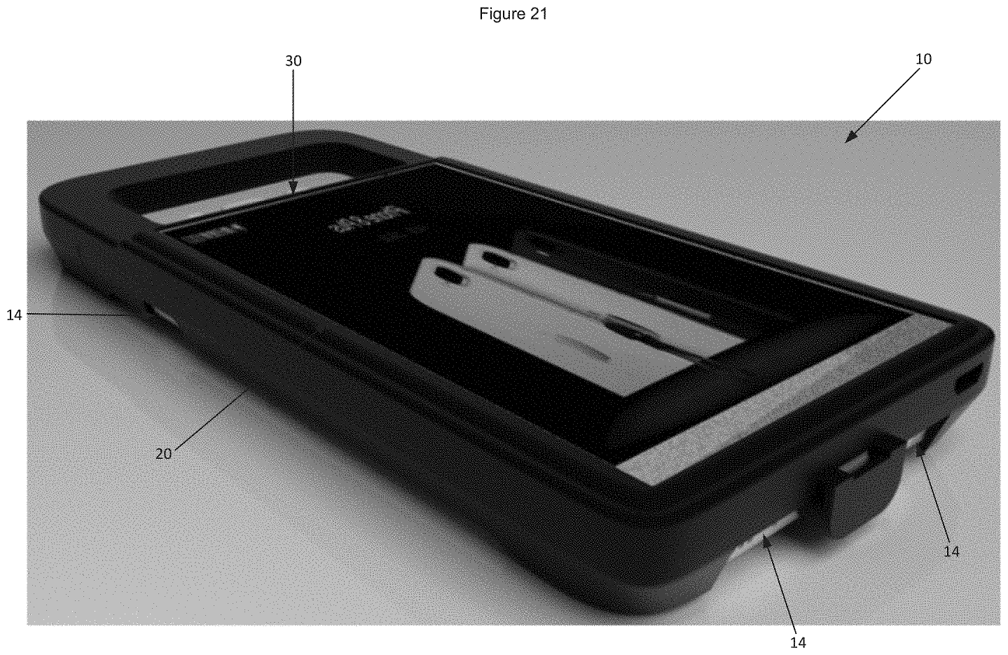

FIG. 22 is a bottom perspective view of a render of the protective display device of FIG. 1;

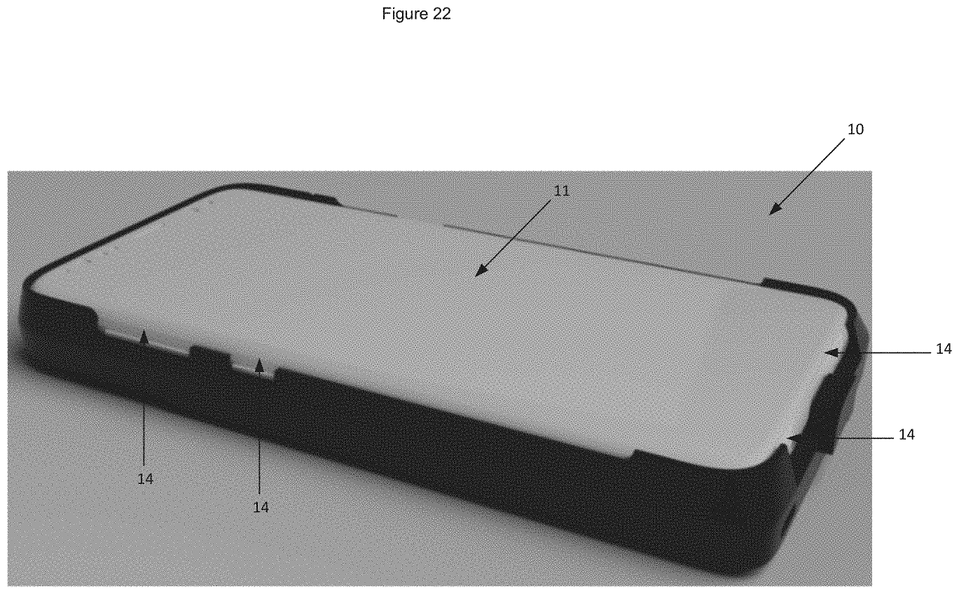

FIG. 23 is a side view of a render of the protective display device of FIG. 1;

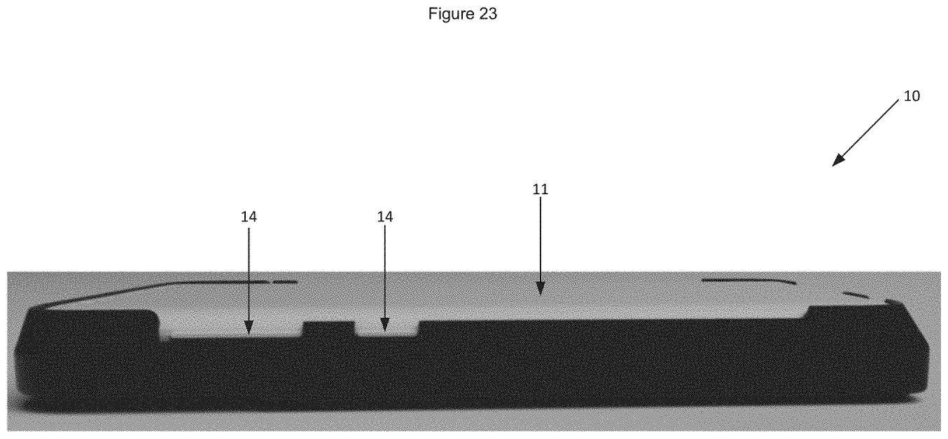

FIG. 24 is a bottom view of a render of the protective display device of FIG. 1;

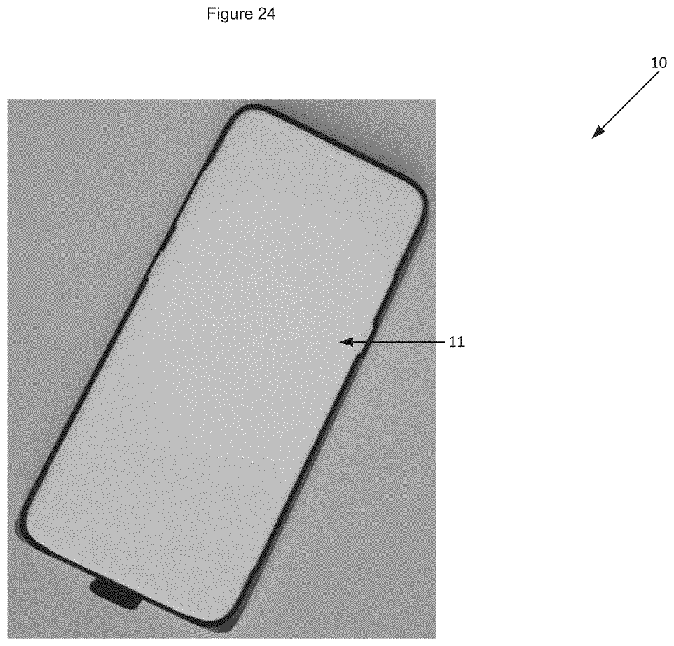

FIG. 25 is a sectional side view of the protective display device of FIG. 1;

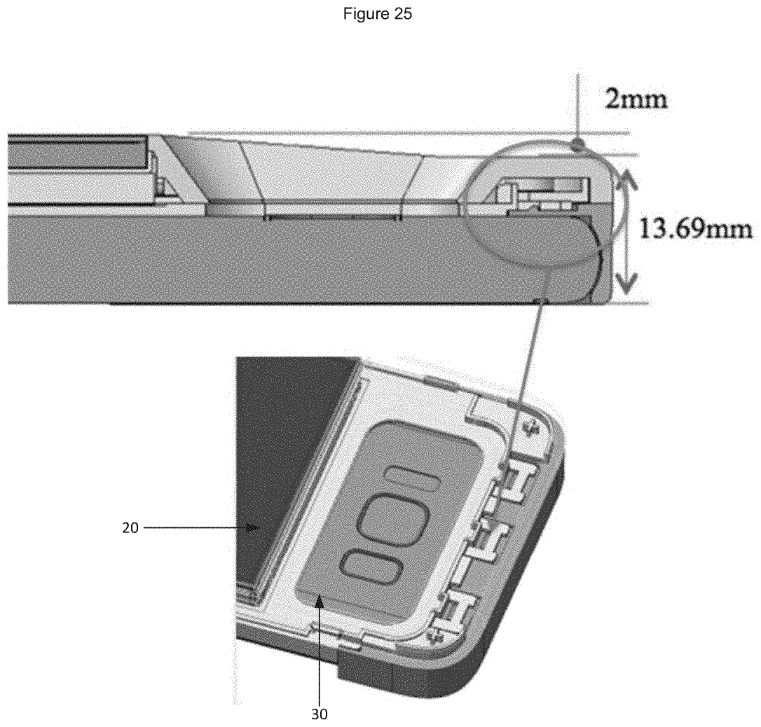

FIG. 26 is a magnified view of a corner of the protective display device of FIG. 1;

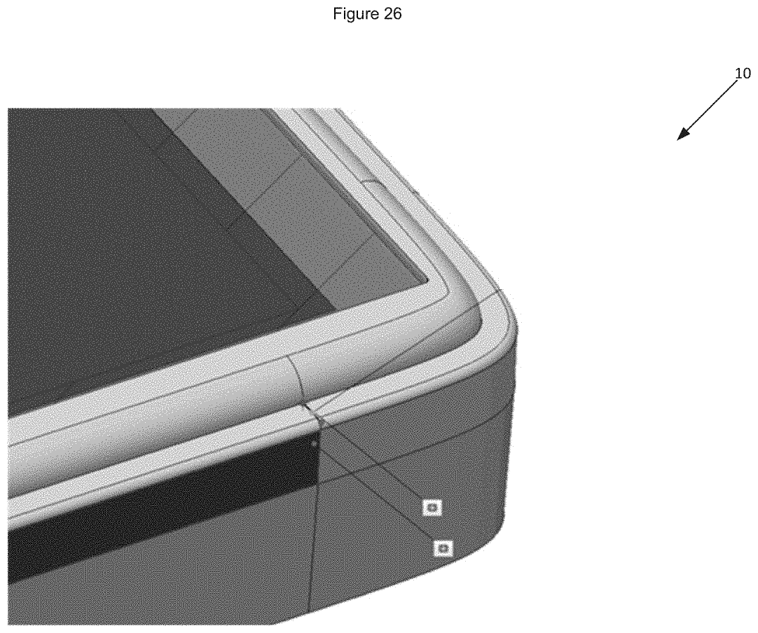

FIG. 27 is a perspective bottom view of the protective display device of FIG. 1;

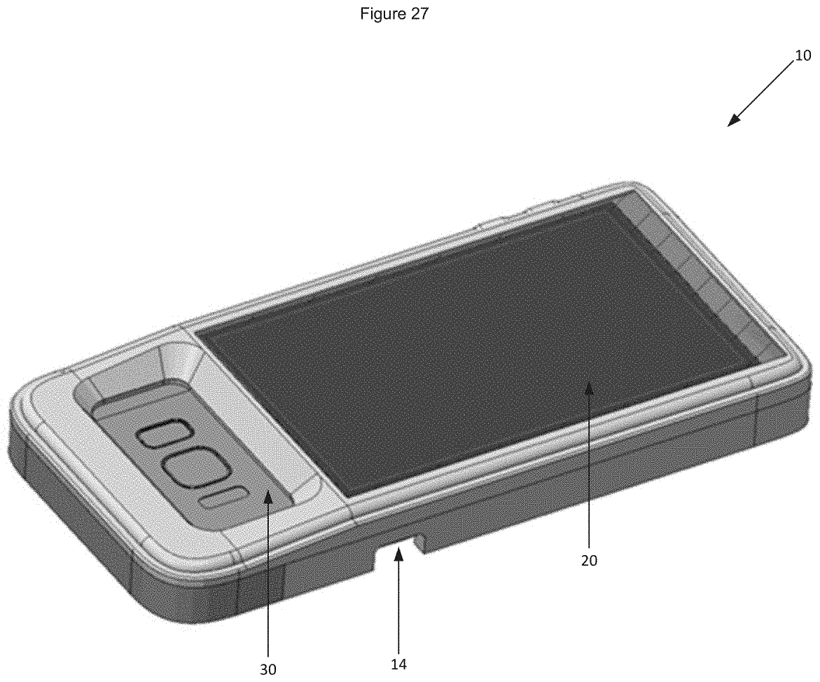

FIG. 28 is a magnified view of a corner of the protective display device of FIG. 1;

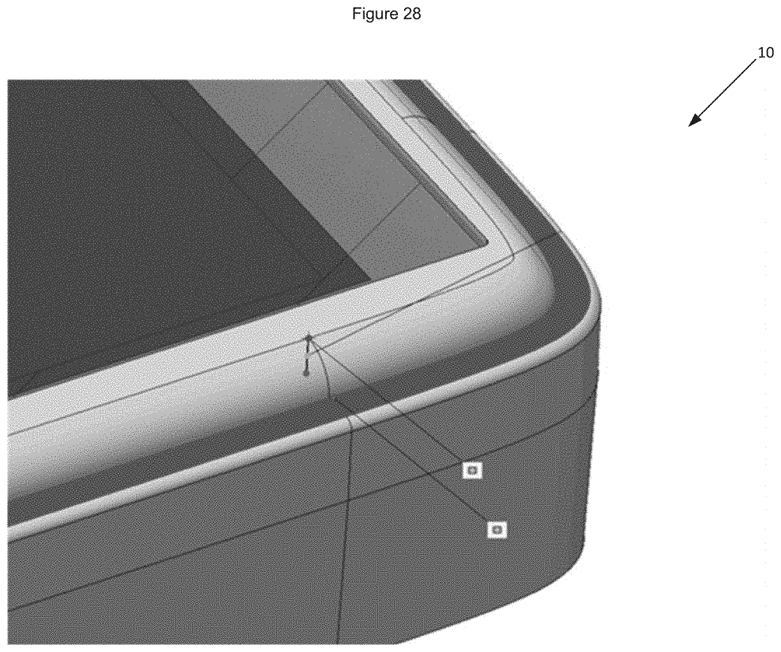

FIG. 29 is a perspective bottom view of the protective display device of FIG. 1;

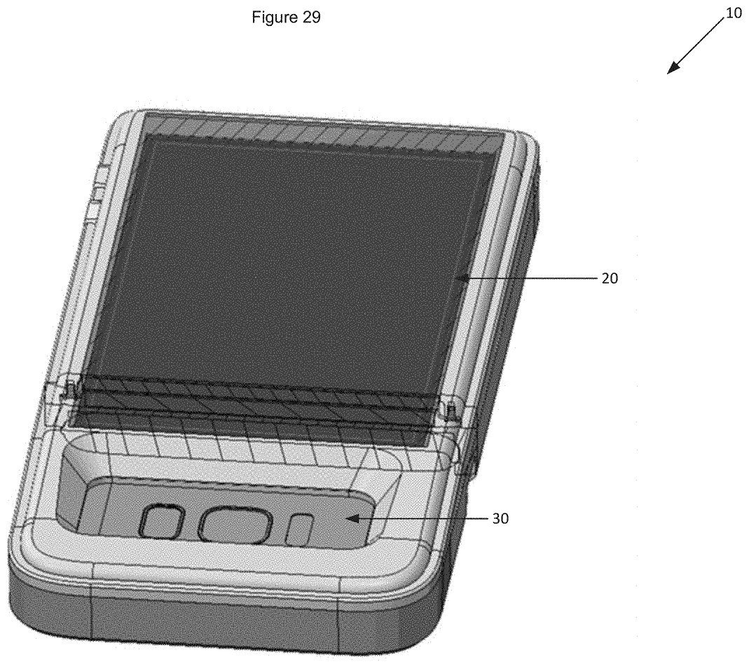

FIG. 30 is a side view of the protective display device of FIG. 1;

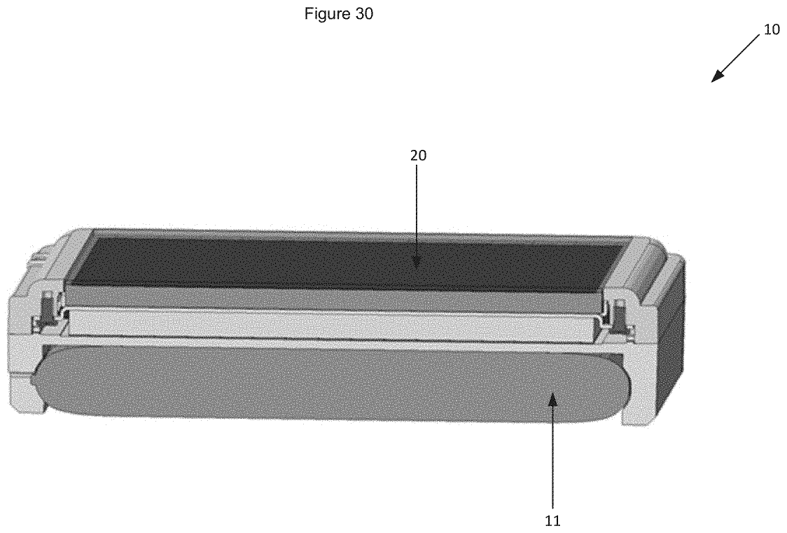

FIG. 31 is an enlarged side view of the protective display device of FIG. 1; and

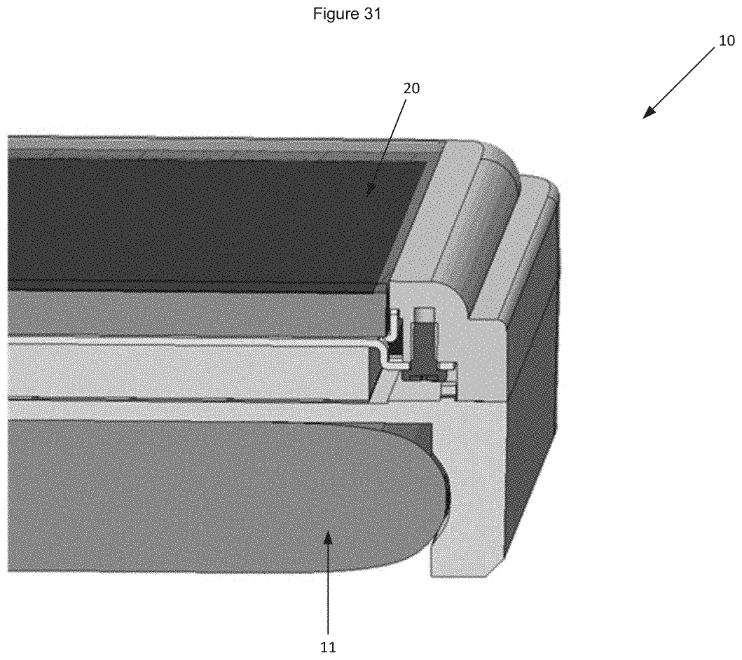

FIG. 32 is a block diagram of the electronic components of the protective display device of FIG. 1.

### DETAILED DESCRIPTION OF THE INVENTION

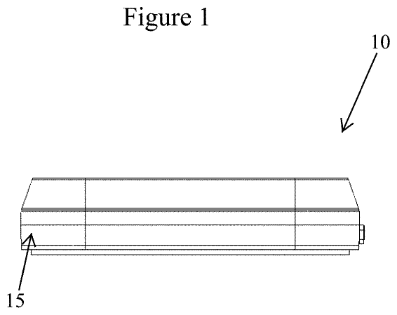

A preferred protective display device according to the present invention is illustrated in FIG. 1 and shown generally at reference numeral 10.

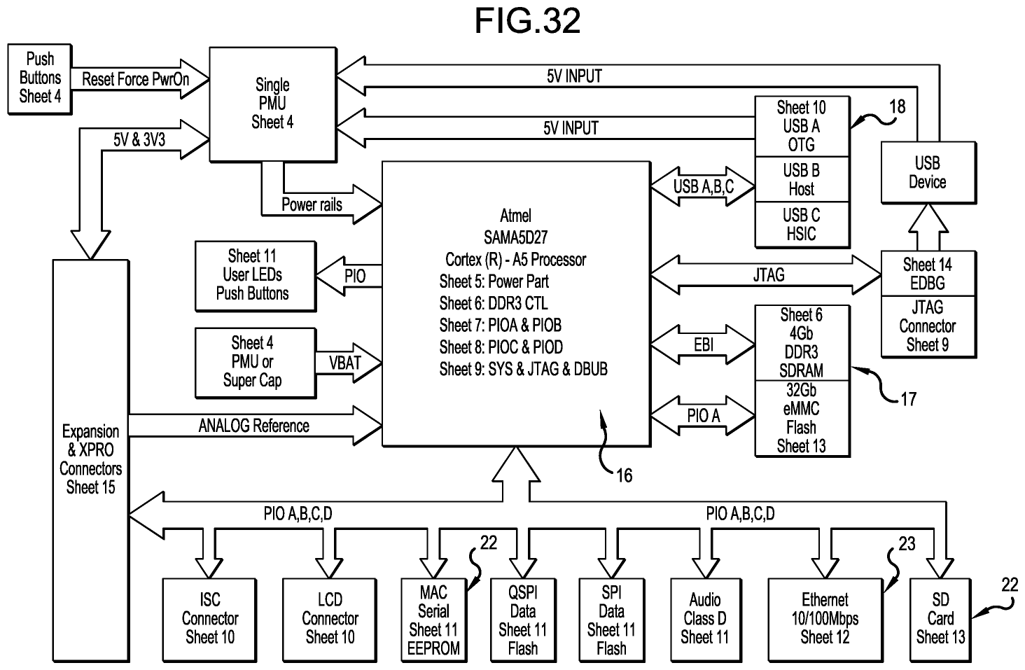

Device 10 is shown in greater detail in FIG. 32. Device 10 includes one or more microprocessors 16 (collectively referred to as CPU) that retrieve data and/or instructions from memory 17 and execute retrieved instructions in a conventional manner. Memory can include persistent memory such as magnetic and/or optical disks, ROM, and PROM and volatile memory such as RAM 17. The CPU may be embodied as a System on chip (SoC) 16 comprising a CPU, GPU, LTE modem, display processor, and video processor 21. For example, the LTE modem may be a Cat. 9 LTE modem.

In the exemplary system 100, the CPU 16 is interfaced to, or otherwise operably associated with, a communications interface 23, one or more user input/output (I/O) interfaces, and local storage, which may comprise a combination of volatile and non-volatile storage. Non-volatile storage may include solid-state non-volatile memory 22, such as read only memory (ROM) flash memory, or the like. Volatile storage 17 may include random access memory (RAM). RAM may be LPDDR4, LPDDR4X or LPDDR5 RAM with a capacity of 32 GB to 256 GB. CPU 16 and memory 17 are connected to one another through a conventional interconnect which is a bus and which connects CPU 16 and memory 17 to a touchscreen display 20.

The storage 22 contains program instructions and transient data relating to the operation of device 10. Storage 22 may contain programs and data content relevant to the normal operation of the device 10. The storage 22 also includes program instructions which, when executed by the processor 16 instruct device 10 to perform operations relating to an embodiment of the invention, for example such as are described below. In some embodiments, device 10 may include additional peripheral interfaces, such as an interface to high-capacity non-volatile storage 22, such as a hard disk drive, optical drive, and so forth. Programs may include operating system programs and data, as well as other executable application software generally unrelated to the present invention.

An operating system is logic implemented by the CPU 16 of device 10 that provides services used by other logic implemented in device 10. The services typically include management of computer resources such as file systems, peripheral device support, networking services, and computer process management. Generally, most users do not directly use an operating system but rather use logic that in turn uses the operating system to perform various tasks. Examples of operating systems in use today in mobile computing devices include the Android mobile operating system produced by Google, Inc., the iOS operating system produced by Apple Computer, and the Windows 7 mobile operating system produced by Microsoft Corp. Applications each define a behaviour performed by device 10. Some of applications are pre-installed before acquisition of device by the end user. Others of applications are installed by the user of device 10.

A number of software components of device 10 are stored in memory 17. In particular, operating system and applications are each all or part of one or more computer processes executing within CPU 16 from memory 17 but can also be implemented using digital logic circuitry.

In a conventional configuration, the storage device 22 maintains known program and data content relevant to the normal operation of the device 10. For example, the storage device 22 may contain operating system programs and data, as well as other executable application software necessary for the intended functions of device 10. The storage device 22 also contains program instructions which, when executed by the processor 16, instruct the device 10 to perform operations relating to an embodiment of the present invention, such as are described in greater detail below. In operation, instructions and data held on the storage device 22 are transferred to volatile memory 17 for execution on demand.

The processor 16 is also operably associated with a communications interface 23 in a conventional manner. The communications interface 23 facilitates access to a data communications network such as the Internet or home network.

In use, the volatile storage 17 contains a corresponding body of program instructions transferred from the storage device 22 or via communications interface 23 and configured to perform processing and other operations embodying features of the present invention.

In the exemplary system 100, device 10 is releasably physically engaged with a mobile computing device 11. The mobile computing device 11 may be a mobile phone or tablet computer, which have their own electronic screen or touchscreen display. Device 10 protects the mobile phone 11 from physical damage, for example, forceful contact with a hard surface or when a load is exerted towards the back surface of the mobile phone 11. Device 10 comprises a casing 15 to provide a predetermined level of physical protection. Casing 15 is injection molded from polycarbonate plastic. Other suitable plastic material is possible. A rigid material provides structural integrity for casing 15 which specifically helps protect the screen 20 from bending, twisting and breaking.

Device 10 also communicates with the mobile phone 11. In one embodiment, all data is received by the device 10 from the mobile phone 11 via a USB connector. The mobile phone 11 slidingly engages with the device 10 and the USB connector of the device 10 is aligned and inserted into a USB port typically located at the bottom surface of the mobile phone 11. The communications interface 23 of device 10 sends data to and receives data from the mobile phone 11 and/or Internet. In another embodiment, the communications is a wireless network interface card 23 in the form a Bluetooth and WiFi combination module. Near Field Communication (NFC) is also envisaged. The Bluetooth communication may be between device 10 and the mobile phone 11. The WiFi communication may be between device 10 and a wireless access point for access to the Internet or private network.

Some wireless data transport protocols provide very low power consumption at the cost of reduced data bandwidth. One example is Bluetooth LE wireless data transport protocol which operates in the 2.4 GHz to 2.4835 GHz ISM band with forty 2 Mhz channels. The present invention may also provide data caching and send only parts of an image to be displayed that differ from the image currently displayed in order to provide a responsive display without increasing power consumption. One advantage of using a wireless data transport protocol between device 10 and mobile phone 11 is that device 10 and mobile phone 11 remain in communication with one another even when device is not engaged with mobile phone 11. Thus device 10 can continue to display data controlled by mobile phone 11 when device 10 is not attached to mobile phone. Also device 10 can display data received from a WiFi connection even when not controlled by mobile phone 11. Device 10 can therefore continue to provide information services on behalf of mobile phone 11 even while mobile phone 11 is placed on a charging cradle in which device 10 does not fit. In addition, device 10 can pair with computing devices other than mobile phone 11 to receive images to display on the touchscreen display 20 such as a laptop or desktop computer.

Display management logic is all or part of or more computer processes executing within CPU 16 from memory 17 but can also be implemented using digital logic circuitry. Display management logic receives and carries out instructions from mobile phone 11 through communications interface 23.

The touchscreen display 20 is an integrated display or screen. The integrated display 20 is located on the outer surface of the back plane of casing 15. The integrated display 20 allows displaying additional information or data to a user. The touchscreen display 20 functions as an input device to facilitate user interaction with software apps. The integrated display 20 can receive images or video from the mobile phone 11. The integrated display 20 can be thin displays such as LCD or LED displays. Preferably, the LCD display 20 is a transmissive type a-Si TFT-LCD (amorphous silicon thin film transistor liquid crystal display) module comprising a TFT-LCD panel, a driver circuit and a backlight unit. The panel size is 4.3 inches and the resolution is 480×800 dots/pixels displaying up to 26K colours. The liquid crystal display module can be accessed by a micro-controller via an MCU interface.

Casing 15 configured to releasably engage the mobile phone 11. In one embodiment, casing 15 of device 10 is physically dimensioned such that the fit on the mobile phone 11 is sufficiently snug to prevent spontaneous dissociation of device 10 and the mobile phone 11. Casing 15 can also appose device 10 and mobile phone 11 using other techniques, such as adhesives, snaps and magnets, for example. Casing 15 is a shell that covers and protects substantially all of the back and sides of mobile phone 11. Casing 15 attaches device 10 to mobile phone 11 and preferably maintains the attachment as long as the user wants the attachment to be maintained.

Casing 15 is shaped to receive or house a mobile phone 11 within a contoured cavity. Casing 15 has an integrated rechargeable power cell 24 capable of providing power to operate and/or recharge a mobile device including the mobile phone 11. This may provide backup or emergency power to the mobile phone 11 via the USB connector of device 10 in the event that the battery of the mobile phone 11 is low or depleted. The USB connector of device 10 when inserted into the USB port of mobile phone 11 enables the batteries of both the mobile phone 11 and device 10 to be recharged at the same when the mobile phone 11 is being recharged, for example, from a power outlet. The power cell 24 may be a thin-film lithium-ion rechargeable battery that can be charged through a small power port in Casing 15. Alternatively, the internal power cell 24 of casing 15 can be recharged wirelessly. Inductive charging uses an electromagnetic field to transfer energy between a charging pad and the internal power cell 24 of casing 15 through electromagnetic induction.

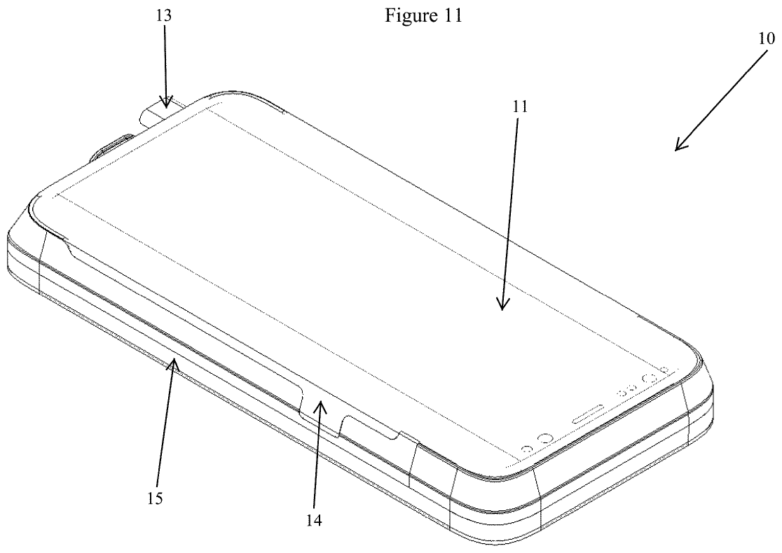

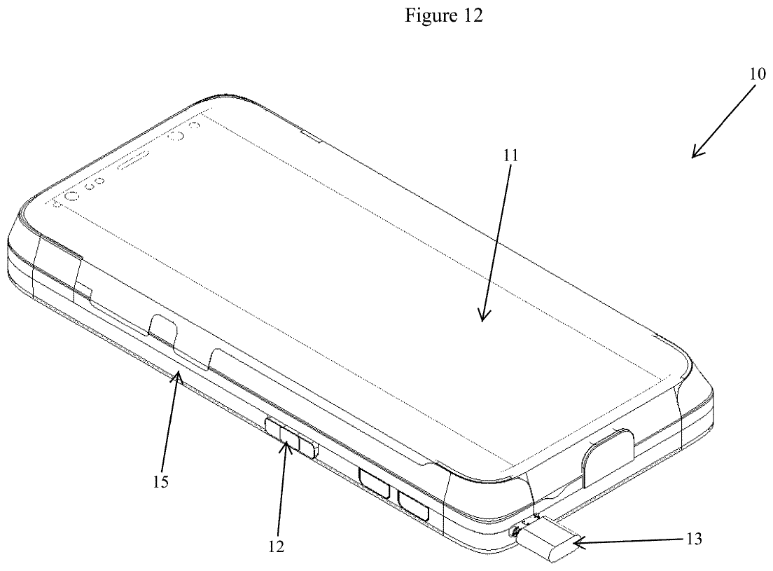

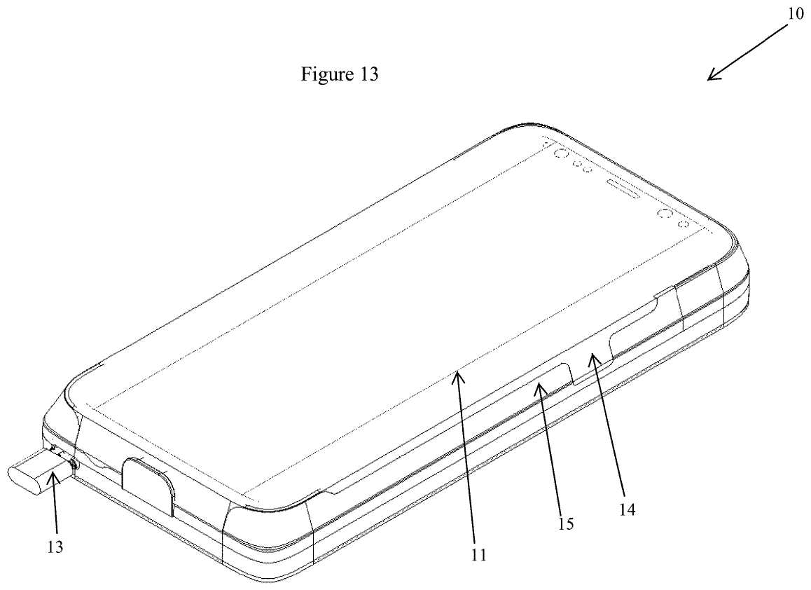

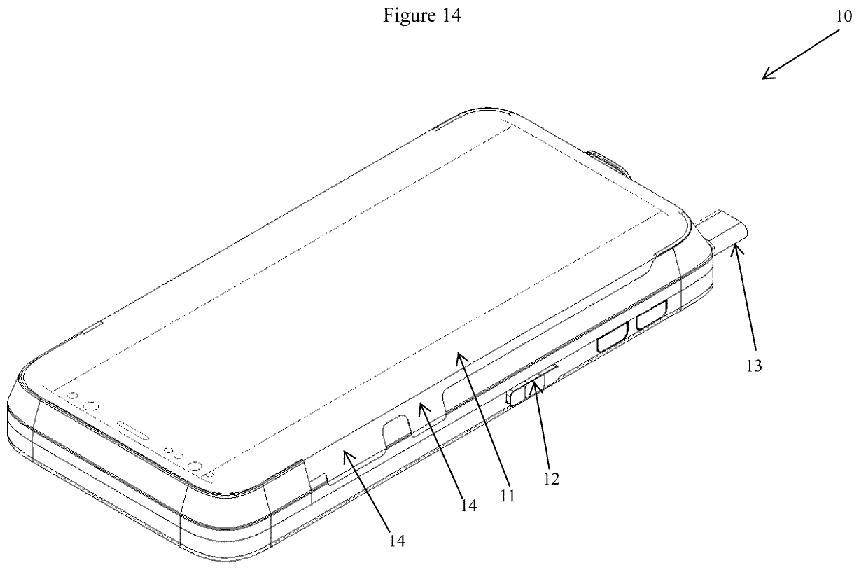

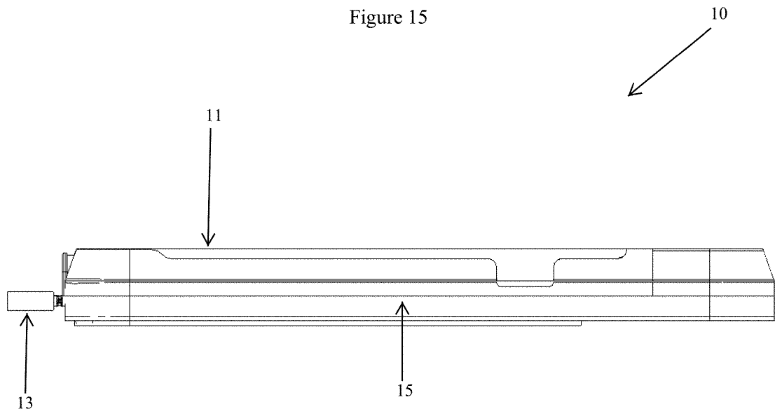

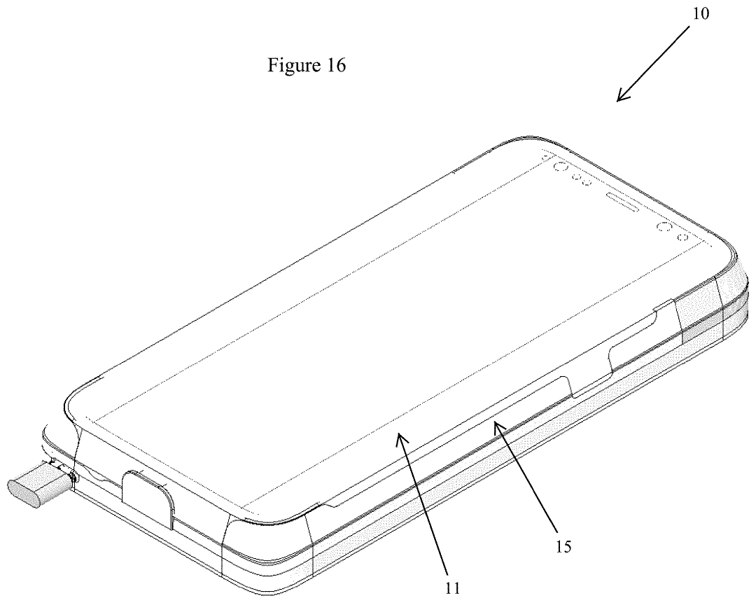

FIGS. 11 to 16 illustrate how a mobile phone 11 can be housed within casing 15 of device 10. As can be appreciated from these figures, casing 15 is shaped to closely wrap around the mobile phone 11 and serves as a protective case for the mobile phone 11.

Casing 15 includes a back plane, first and second sides, a bottom side and a top side. The back plane, first and second sides, a bottom side and the top side may be shaped to form a pocket or cavity in which a mobile phone 11 can be housed.

Casing 15 may have a plurality of recesses or openings 14. A first opening 30 located at an upper region on the back plane of casing 15 may allow unobstructed view for a camera lens on the back of the mobile phone 11. A second opening may provide access to a screen on/off switch for the mobile phone 11. A third opening may provide access to an audio jack on the mobile phone 11. A fourth opening may provide access to a volume control sliding switch on the mobile phone 11. A fifth opening may provide an unobstructed space to a speaker on the mobile phone 11.

Casing 15 may also include an external connector or external interface 18 within the cavity, for example, on the bottom side, through which power can be provided to the mobile phone 11 from the internal power cell 24 of casing 15. The external connector or external interface may provide input and/or output data signals to the mobile phone 11. The external connector or external interface may be a micro USB port 18 and can be used to recharge the internal power cell 24 of casing 15.

The back plane of casing 15 has an interior surface and an exterior surface which form a top and bottom shell in between which one or more circuit boards 18 and/or one or more power cells 24 are housed. That is, the circuit boards 18 and/or power cells 24 are sandwiched between the interior and exterior surfaces of the back plane. Consequently, the circuit boards 18 and power cells 24 are housed within the thickness of the back plane of casing 15.

The circuit boards 18 and/or power cell 24 of device 10 may cause interference with the antenna or signalling of the mobile phone 11 which is in close proximity. Consequently, reducing the size of the circuit board 18 by adding secondary circuit boards which are electrically coupled together may reduce interference to the antenna of the mobile phone 11. Additionally, the ground for the power cell 24 may be coupled to the ground for the mobile phone 11 to reduce interference to the mobile phone 11.

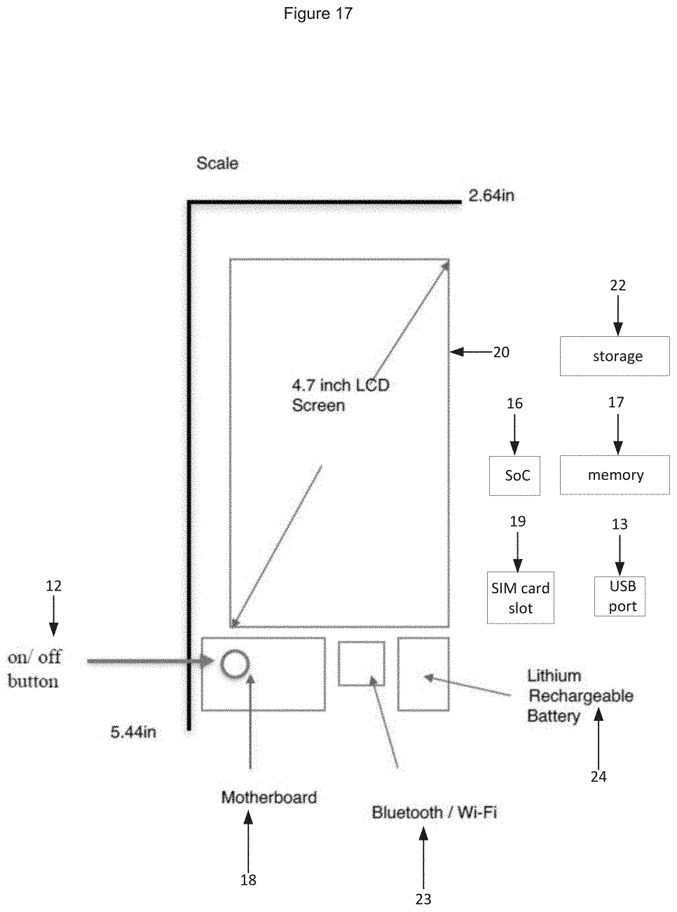

Device 10 is a physical apparatus that releasably attaches to the back of a mobile phone 11. Device 10 includes an electronic display 20. Referring to FIG. 17, the dimensions and layout of device 10 are depicted. The USB port 18 is included in casing 15 for charging and for uploading data such as photos from a USB mass storage device. The physical size of the battery 24 may be 3 to 4 mm thick. The physical size of the battery 24 must balance between the physical constraints of available space and being capable of maintaining the display 20 in an “always on” mode for as long as possible. To conserve battery life, the screen 20 may dim after a predetermined amount of time. A movement sensor 25 may be included in device 10 so that the screen 20 awakens when the phone 11 is moved. Alternatively, device 10 is programmed to use sensing data obtained by the mobile phone's sensors (e.g. gyroscope or accelerometer) to conserve its battery 24. If the mobile phone 11 is placed face down for a predetermined amount of time device 10 will activate into sleep mode. Device 10 will also be activated into sleep mode if the mobile phone 11 has been inactive for predetermined amount of time.

Device 10 also comprises a series of physical buttons 12. There is an on/off button which if pressed can activate or deactivate the screen 20 or if depressed for longer amount a time, cause device 10 either turn on or off.

Example Software Applications

Device has 10 been designed to be controlled using an intuitive and easy to use mobile software application (app) on the mobile phone 11. The app can be updated and remotely distributed to devices 10. Software functionality provided to device 10 includes: a picture frame or photo display; a live feed from the camera of the mobile phone 11 that is displayed on the display 20 of device 10; sleep mode with on/off option; emergency charge; and dual charging.

The user holds the on/off button for two (2) seconds and the display 20 would change to ‘sleep’ mode but remain active and ready so that if a telephone call arrives, for example, an image would appear, and the call can be answered.

Emergency charge allows the mobile phone 11 to draw on the battery 24 of device 10 for power. Primary charge allows a USB cable with a USB connector or a USB connector of the device 10 to be inserted into the USB slot 18 to charge the device 10. The phone 11 can be recharged using the same USB cable from power stored in device 10. The user can select through the app if they would like the emergency battery feature to be on/off. If on, when the mobile phone's battery falls below a certain power percentage, device 10 will go into sleep mode and the mobile phone 11 will use the battery supply of device 10 to recharge. Device 10, depending on its current charge level, can provide an additional 25% to 30% power to the mobile phone 11.

Device 10 allows the display of advertising on device 10 as a mobile advertising platform. It will be the next digital billboard in the palm of everyone's hand, you can see the back of almost everyone's phone who is using public transport or just walking around talking.

Device 10 may present a user interface with a plurality of virtual buttons. Virtual button 1 is a menu consisting of: help, contact us, and how to use. If an info menu button is selected, a popup menu will display the following. If the help menu button is selected, an additional popup menu will bring up troubleshooting options for any issues or concerns. If the contact us menu button is selected, an additional popup menu will provide data on how users can reach us as well as website and company details. If the how to use menu button is selected then an additional popup menu will provide date which will be a how to guide on how to use the app on the mobile phone 11.

Virtual button 2: Mirror Override. This has two options on/off: If on, device 10 will mirror exactly what is on the mobile phone 11. If on this overrides any other function of device 10 as it will only be replicating exactly what the display of the mobile phone 11 is showing. If off, the functionality is deactivated. device 10 switches back to the Customise Options and device 10 will display photos as per usual. If the mirror button is selected a pop up menu will appear with two options: turn mirror on or turn mirror off.

Virtual button 3: Vanity. This is a feature links to the camera of the mobile phone 11. There are two options on/off. If on, whenever the camera on the mobile phone 11 is being used to take photos, the camera image will also be shown on device 10. If off, the camera image will not show and device 10 will continue to run as normal. The purpose of the vanity button is so the people being photographed can see what the photo/video will look like as a live preview. This will allow anyone on the other side of the camera to view what the video or photo looks like live while it is happening. Device 10 can rotate (manually or automatically by detection using the gyroscope or accelerometer) between from landscape to portrait orientation.

Virtual button 4: Custom Setting. This has the following options: Push Notifications Yes/No; Display Text Messages Yes/No; Calendar Reminders Yes/No; Incoming caller and number Yes/No; Slideshow On or Off; Options: Change photo every 1 minute, Change photo every 10 minutes, Change photo every 30 minutes; Battery Saver Option—On/Off mins; Time and date—On/Off. When the user selects the customize button it will take them to a separate pop up menu which will display the following options: Push Notifications Yes/No. If on all push notifications will be displayed. Display Text Messages Yes/No. Calendar Reminders Yes/No. Incoming caller and number Yes/No. Pop Up notifications, txt messages or calendar reminders—Yes or No option—If yes These will only appear on device for 10 seconds and disappear. As device 10 comprises a touchscreen display 20, a user can swipe off the screen 20 earlier. If Yes when someone calls there name and number will be displayed on device 10. When phone call is answered the called will disappear and it will return to normal appearance. If no—name and number will not appear. Slideshow On or Off-User decides how often to change photo—It would be ideal if the user could select any time instead of only a couple of options. Options: Change photo every 1 minute, Change photo every 10 minutes, Change photo every 30 minutes. The user will use the lock button on device 10 if they would like only one photo to be displayed. Battery Saver Option—On/Off mins—This is a very important feature—If on, the mobile phone's GPS sensor is used to sense if the mobile phone 11 is moving or active. If moving or active, device 10 is immediately turned on. If the mobile phone 11 is inactive for 15 minutes then it will automatically switch off to conserve battery power. If Battery saver is off—Then device 10 will always remain on. Date and time—On or Off—if you want date and time to be displayed on device 10 in the top right corner

Virtual button 5: Access the mobile phone photo album. Users can then send the photos via Bluetooth or WiFi or via the USB connector to memory 17 of device 10. The purpose of this button is to access the mobile phone's photo album. When selected the app will take the user into the photo album. The user can then go through and select a single or multiple photos to send to device 10. Each time a photo is selected it will display on the entire screen 20 and its size can be re-scaled. Click send button—photos will send to device 10 via Bluetooth or WiFi or the USB connector. An extra button may be added to auto scale photos full screen—if this is selected then people do not need to scale every photo manually. Alternatively, the photos can be auto scaled directly on the touchscreen display 20.

Unless specified to the contrary, any and all components herein described are understood to be capable of being manufactured and, as such, may be manufactured together or separately.

Moreover, in interpreting the disclosure, all terms should be interpreted in the broadest reasonable manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

The subject headings used in the detailed description are included only for the ease of reference of the reader and should not be used to limit the subject matter found throughout the disclosure or the claims. The subject headings should not be used in construing the scope of the claims or the claim limitations.

Although the technology herein has been described with reference to particular examples, it is to be understood that these examples are merely illustrative of the principles and applications of the technology. In some instances, the terminology and symbols may imply specific details that are not required to practice the technology. For example, although the terms “first” and “second” may be used, unless otherwise specified, they are not intended to indicate any order but may be utilised to distinguish between distinct elements.

It is therefore to be understood that numerous modifications may be made to the illustrative examples and that other arrangements may be devised without departing from the spirit and scope of the technology.

1. A protective display device for a mobile communication device having a first electronic screen, the protective display device comprising:
a casing defining a cavity that conforms at least partially to a rear outer shape of the mobile communication device, the casing configured to releasably engage the mobile communication device;
an upper opening of the casing positioned and sized to avoid obstructing a plurality of rear electronic components located on the rear side of the mobile communication device;
a second electronic screen that is different from the first electronic screen and is attached to the casing such that the second electronic screen is visible to a user when the device is attached to the mobile communication device;
a communications module housed within a thickness of the casing configured to transmit and receive data from the mobile communication device and Internet;
a computer processor housed within the thickness of the casing operatively connected to the second electronic screen that is configured to control an image displayed by the second electronic screen in accordance with data received from the communications module, such that the protective display device is operable in accordance with the data from the mobile communication device received via the communications module and is operable independent of the mobile communications device in accordance with the data from the Internet received via the communications module; and
at least one rechargeable power cell housed within the thickness of the casing to supply power to the second electronic screen, the communications module and the computer processor, and when the casing is engaged with the mobile communication device the at least one rechargeable power cell is configured to supply power to the mobile communication device and receive power via the mobile communication device if being charged from a power outlet,
wherein the communications module uses a wireless data transport protocol such that the communications module continues to receive data from the mobile communication device when the casing is not engaged with the mobile communication device, and wherein the data received when the casing is not engaged with the mobile communication device is displayed on the second electronic screen while the casing is not engaged with the mobile communication device.

2. The device according to claim 1, wherein the casing comprises a plurality of openings and recesses positioned and sized to expose a volume rocker, power switch button, power supply port, speaker and microphone of the mobile communication device.

3. The device according to claim 1, wherein the plurality of rear electronic components includes any one from the group consisting of: camera, image sensor, image processor, LED flash module, ambient light sensor, and fingerprint scanner.

4. The device according to claim 1, further comprising a USB port configured to provide power from the at least one rechargeable cell to the mobile communication device via a USB cable, and to connect to a USB mass storage device for file transfer.

5. The device according to claim 1, wherein the second electronic screen is a touchscreen display.

6. The device according to claim 1, wherein the second electronic screen has a predetermined size of at least half an area of a rear side surface of the mobile communication device.

7. The device according to claim 1, wherein the casing comprises a peripheral side wall to resiliently engage with a peripheral side of the mobile communication device.

8. The device according to claim 7, wherein the peripheral side wall of the casing comprises a plurality of buttons including an on/off button.

9. The device according to claim 1, wherein the second electronic screen displays a user interface having virtual buttons, wherein one of the virtual buttons is a vanity button, and wherein when the vanity button is turned on, a camera of the mobile communications device is linked to the protective display device such that a live image displayed on the first electronic screen is simultaneously displayed on the second electronic screen.

10. The protective display device according to claim 1, wherein the second electronic screen displays a user interface having virtual buttons, wherein one of the virtual buttons is a mirror override button, and wherein when the mirror override button is turned on, the second electronic screen will display a same image as being displayed on the first electronic screen of the mobile communications device.
